(19) United States
(12) Patent Application Publication
(10) Pub. No.: US 2024/0184625 A1
(43) Pub. Date: Jun. 6, 2024

(54) METHOD, APPARATUS, AND SYSTEM WITH JOB MANAGEMENT

(71) Applicant: SAMSUNG ELECTRONICS CO., LTD., Suwon-si (KR)

(72) Inventors: Jongseok KIM, Suwon-si (KR); Youngmin KIM, Suwon-si (KR); Jonghoon YOON, Suwon-si (KR); SUNG-JAE CHO, Suwon-si (KR); Changyong SON, Suwon-si (KR)

(73) Assignee: SAMSUNG ELECTRONICS CO., LTD., Suwon-si (KR)

(21) Appl. No.: 18/480,924

(22) Filed: Oct. 4, 2023

(30) Foreign Application Priority Data
Dec. 1, 2022 (KR) 10-2022-0166040

(51) Int. Cl. G06F 9/48

(52) U.S. Cl. CPC G06F 9/4881

(57) ABSTRACT

A method of a system including a processor including recording experiment information of a job in connection with job information generated based on an execution of a job of a computer cluster system, and controlling further execution of a job, by the computer cluster system, by transmitting a change in the experiment information to the computer cluster system based on the job information.

### CROSS-REFERENCE TO RELATED APPLICATIONS

This application claims the benefit under 35 USC § 119(a) of Korean Patent Application No. 10-2022-0166040, filed on Dec. 1, 2022, in the Korean Intellectual Property Office, the entire disclosure of which is incorporated herein by reference for all purposes.

### BACKGROUND

### 1. Field

The following description relates to a method and apparatus with job management.

### 2. Description of Related Art

In the field of machine learning, many hyperparameters may be generated in connection with the training and execution of the machine learning models.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is a method of a system including a processor including recording experiment information of a job in connection with job information generated based on an execution of the job in a computer cluster system and controlling further execution, by the computer cluster system, of the job by transmitting a change in the experiment information to the computer cluster system based on the job information.

The job information may include a job identifier of the job and the recording of the experiment information may include mapping the experiment information to the job identifier of the job and recording the mapped experiment information.

The job information may include a job identifier of the job, the experiment information may include an experiment identifier of the job, and the recording of the experiment information may include mapping the job identifier and the experiment identifier.

The method may include updating the experiment information of the job, based on the execution of the job.

The controlling of the execution of the job may include receiving an input and, based on the input, setting the change of the experiment information based on the job information and transmitting the input to change the experiment information to the computer cluster system so that a computing resource for executing the job of the computer cluster system is controlled.

The system may include the computer cluster system, and the input to change the experiment information may include one or more of an input for interrupting the execution of the job, resuming the execution of the job by the computer cluster system, changing at least one parameter related to the execution of the job, and updating the at least one parameter.

The method may include recording the job information prior to the recording of the experiment information by monitoring a job queue and the job may be stored in the job queue of the computer cluster system.

The monitoring of the job queue may include generating the job information of the job based on an enqueuing of the job queue and updating the job information of the job based on a dequeuing of the job queue.

The method may include generating the experiment information of the job based on the dequeuing of the job queue.

The job information may include a job identifier of the job, information on a scheduling status of the job, information on an execution code of the job. and time information on a processing of the job.

The experiment information may include an experiment identifier of the job, parameter information on the execution of the job, measurement information on the execution of the job, information on a computing resource executing the job, and information on an execution time of the job.

The method may include providing one or more of the job information and the experiment information through an interface.

The job may be a job for a machine learning experiment and the experiment information includes the parameter information corresponding to parameters of the machine learning experiment.

In a general aspect, here is provided a system including a server that includes a processor configured to execute a plurality of instructions and a memory storing the plurality of instructions, wherein execution of the plurality of instructions configures the processor to be configured to record experiment information of a job in connection with job information based on an execution of the job in a computer cluster system and control the execution of the job by transmitting a change in the experiment information to a computer cluster system based on the job information.

The system may include a memory store that may be configured to store the job information and the experiment information.

The processor may be configured to record the job information and the experiment information in an external storage device of the system and the server may include a communication module configured to communicate with the external storage device.

The job information may include a job identifier of the job and the processor may be configured, for the recording of the experiment information of the job in connection with the job information, map the experiment information to the job identifier of the job and record the mapped experiment information.

The job information may include the job identifier of the job, the experiment information may include an experiment identifier of the job, and the processor may be configured to, for the recording of the experiment information of the job in connection with the job information, map the job identifier and the experiment identifier.

The processor may be configured to, for the controlling of the execution of the job, receive an input to change the experiment information based on the job information and transmit the input to the computer cluster system to control a computing resource for executing the job of the computer cluster system.

Other features and aspects will be apparent from the following detailed description, the drawings, and the claims.

### BRIEF DESCRIPTION OF THE DRAWINGS

FIG. 1 illustrates an example of a computing system with job management according to one or more embodiments.

FIG. 2 illustrates an example of a high-performance computing (HPC) system according to one or more embodiments.

FIG. 3 illustrates an example management method of cluster jobs to be processed in a computer cluster system according to one or more embodiments.

FIG. 4 illustrates an example interface screen for managing jobs output to a user terminal according to one or more embodiments.

FIG. 5 illustrates an example interface screen for providing information on a job according to one or more embodiments.

FIG. 6 illustrates an example of a configuration of an apparatus and computing system according to one or more embodiments.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Due to manufacturing techniques and/or tolerances, variations of the shapes shown in the drawings may occur. Thus, the examples described herein are not limited to the specific shapes shown in the drawings, but include changes in shape that occur during manufacturing.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. Embodiments of the disclosure may include a device that tracks and controls operations in a machine learning operations (MLops) system which may deploy and maintain machine learning models in a reliable and efficient manner. While a machine learning model is being trained, the hyperparameters that are used for learning, a learning code, and the performance of the model may be recorded and saved. The recorded hyperparameter information may provide experimental results to a user through a user interface during a learning process or after learning has been completed, and may provide functionality for searching the experiment results, as well as for comparing experiment results from among different experiments.

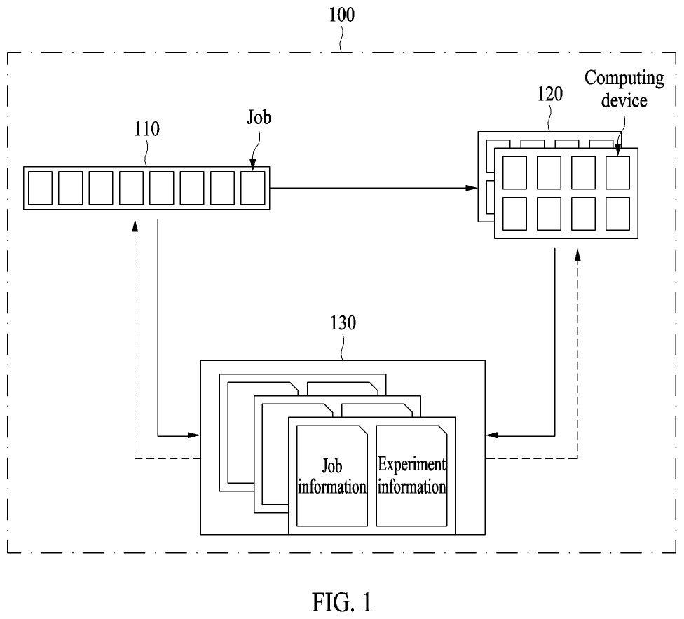

FIG. 1 illustrates an example of a computing system with job management according to one or more embodiments.

Referring to FIG. 1, a computing system 100 may include a store 110 for a job to be processed, a computer cluster 120 for executing the job, and a job managing server 130, i.e., a server with job management, configured to perform job management duties and operations.

In an example, the computer cluster 120 may be a set of a plurality of computing devices (e.g., servers and computers), and may process operations for the execution of jobs. A computing device may include computing resources (e.g., a graphics processing unit (GPU), a central processing unit (CPU), memory, and the like). For example, the computer cluster 120 may parallelly process operations for the execution of a job using the computing resources of a plurality of computing devices.

The store 110 may be a space in which the jobs to be processed by the computer cluster 120 are stored, and may include, for example, data structures such as a queue and a stack. The jobs stored in the store 110 may correspond to jobs waiting to be processed by the computer cluster 120. Because the jobs that are stored in the store 110 may not be currently active, these jobs being stored in the store 110 may correspond to jobs to which the computing resources of the computer cluster 120 are not allocated. In an example, the jobs being stored in the store 110 may, at one point, be allocated to the computing resources of the computer cluster 120. In an example, the jobs may be allocated according to a scheduling rule implemented by a scheduler. In an example, when the jobs have computing resources allocated, these allocated jobs may then be deleted from the store 110.

As a non-limiting example, when job managing server 130 executes a job, the job managing server 130 may record job information and experiment information for that job, and may provide an interface for through which the job information and experiment information may be accessed and/or provided by/to a user, for example, using an I/O interface (e.g., Input Interface 707 of FIG. 7) of the computing system 100. The job managing server 130 may control the execution of a job by the computer cluster 120 based on the job information and experiment information. For example, the job managing server 130 may receive an input to change the experiment information from a user through an interface and transmit a command to control the execution of a job to the computer cluster 120.

In an example, the server 130 may correspond to an internal server of a system to execute a job, which includes the computer cluster 120 and the store 110, or an external server operating in connection with the system to execute a job, which includes the computer cluster 120 and the store 110.

In an example, the system to execute a job including the computer cluster 120 and the store (i.e., one or more memories) 110 may include a high-performance computing (HPC) system. The server 130 may be implemented as an internal server of an HPC system included in the HPC system, or may be implemented as an external server of an HPC system operating in connection with the HPC system.

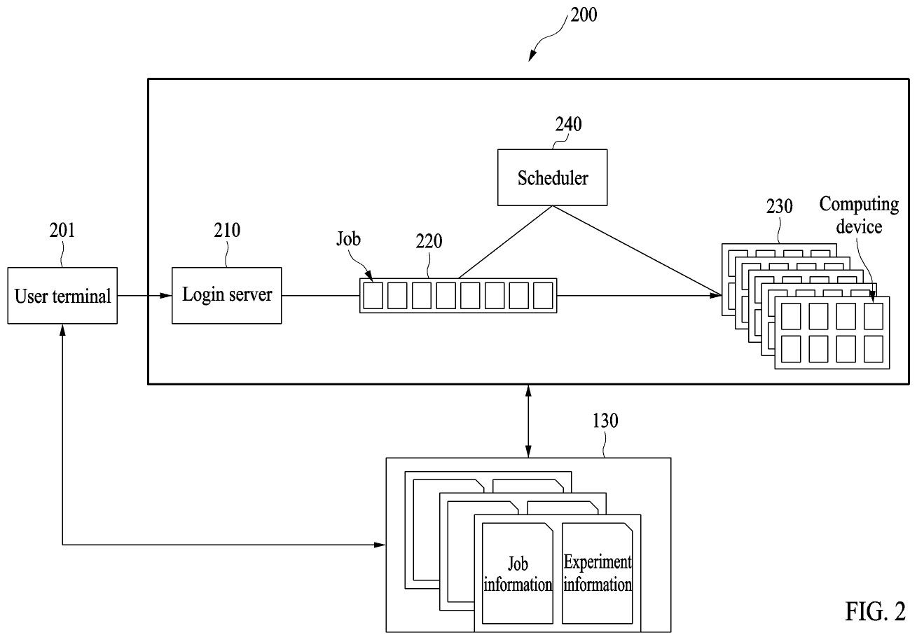

FIG. 2 illustrates an example detailed structure of an HPC system according to one or more embodiments.

Referring to FIG. 2, an HPC system 200 may include a login server 210, a job queue 220, a computer cluster 230, and a scheduler 240. For example, the job queue 220 may correspond to the store 110 of FIG. 1. As a non-limiting example, the computer cluster 230 may correspond to the computer cluster 120 of FIG. 1.

A user terminal 201 may access the login server 210 of the HPC system 200 through a network. The user terminal 201 may be used to provide a request to execute a job to the login server 210. The login server 210 may register the job received from the user terminal 201 in the job queue 220.

The job queue 220 may store one or more jobs that were requested, to be executed, by one or more user terminals 201. In an example, the job queue 220 may store the jobs in an order in which execution is requested, and computing resources may be allocated sequentially according to the order in which the jobs are first stored in the job queue 220. In another example, the jobs may executed in a predetermined or determined preferred order or in an order dictated by a job priority.

The scheduler 240 of the HPC system 200 may determine the available computing resources of the computer cluster 230 and an amount of the computing resources required for the job, and allocate the computing resources of the computer cluster 230 to the job.

In an example, the HPC system 200 may include a store (e.g., the store 110 of FIG. 1) corresponding to another type of data structure for storing jobs waiting to be executed other than the job queue 220. For example, a job may be stored in a store having a stack data structure or a store having a data structure in which an order of inputs and outputs is not determined. When a job is stored in a store having a data structure in which an order of inputs and outputs is not determined, the scheduler 240 of the HPC system 200 may determine the available computing resources of the computer cluster 230 and an amount of computing resources required for the stored job, and allocate the computing resources to the job according to a scheduling rule or scheduling algorithm.

In an example, the job managing server, such as the job managing server 130 of FIG. 1, though examples are not limited thereto, may operate in conjunction with the HPC system 200 and the user terminal 201. For example, the job managing server 130 may monitor the job queue 220 and obtain information on jobs stored in the job queue 220. For example, the job managing server 130 may monitor the execution of a job by the computer cluster 230 and obtain execution information of the job by the computer cluster 230.

The job managing server 130 may store job information and execution information in connection with each other for each job. For example, storing the job information and execution information in connection with each other may refer to mapping and storing the job information and execution information corresponding to that job. The job managing server 130 may access a job stored in the job queue 220 based on the job information and execution information. The job managing server 130 may control the execution of a job of the computer cluster 120 based on the job information and execution information.

The job managing server 130 may interact with the user terminal 201 through an interface. In an example, the job managing server 130 may provide job information and experiment information recorded for each job to the user terminal 201 through an interface. For example, the job information and experiment information recorded for each job may be provided through an interface screen output on a display of the user terminal 201. The job managing server 130 may receive a command or input signal from the user terminal 201 through the interface. For example, the job managing server 130 may receive a command or input signal for controlling a job executed in the HPC system 200 from the user terminal 201. The command or input signal for controlling the job executed in the HPC system 200 may be transmitted to the HPC system 200 to control computing resources of the computer cluster 230 that are executing the job. The operation of the job managing server 130 will be described in detail below.

In an example, the job managing server 130 may be included in the HPC system 200, or may be an external server of the HPC system 200 that can access the HPC system 200.

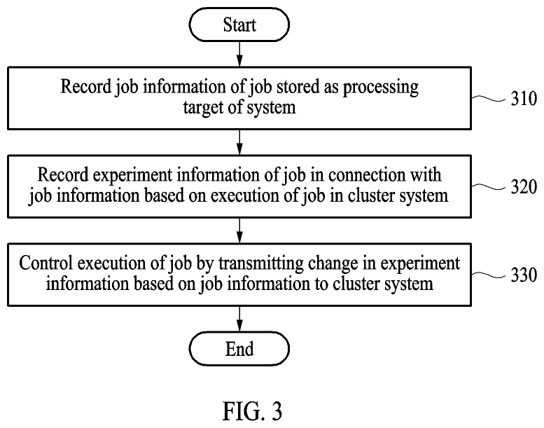

FIG. 3 illustrates an example management method of jobs processed in a computer cluster system according to one or more embodiments.

A computer cluster system may be a system including a cluster including a set of a plurality of computing devices (e.g., servers and computers) for processing jobs, and may include, for example, an HPC system. For example, the computer cluster system may correspond to the computing system 100 of FIG. 1 and/or the HPC system 200 of FIG. 2.

In an example, a management method of a job processed in a cluster system may be performed in a job managing server. As a non-limiting example, the job managing server may correspond to the job managing server 130 of FIG. 1 or the job managing server 130 of FIG. 2.

Referring to FIG. 3, the management method of a job processed in the cluster system may include recording 310 job information of a job stored as a processing target of the system. A job is a processing target of a computer cluster system, and may include a set of code or instructions executed by computing resources. For example, a job may include a job for machine learning experiments. A job for machine learning experiments may include a set of code or instructions for training a machine learning model.

In an example, a job may be stored in a store of a system prior to being allocated to the computing resources of the system for execution. For example, a job may be stored in a job queue of the system.

In an example, the job managing server may record job information of one or more jobs stored in the system. The job information may be stored in a memory of the job managing server or in a storage space (e.g., database) accessible from the job managing server.

The job information of a job may be information indicating aspects of the job and may include, for example, any one or any combination of information included in the job, information obtainable from the job, information on a save state of the job, and information on whether the job is being or has been executed.

For example, the job information may include a job identifier of the job. The job identifier is information uniquely assigned to each job, and may include, for example, a character string generated by a combination of numbers and letters.

For example, the job information may include information on a scheduling status of a job. The scheduling status of a job may be information indicating whether computing resources have been allocated to the job, and may include, for example, information indicating an allocated status and information indicating an unallocated status (or a pending state).

For example, the job information may include information on an execution code of a job. The information on the execution code of the job may include a set of code and/or instructions corresponding to the job.

For example, the job information may include information on the waiting time of a job. The information on the waiting time of a job may be time information corresponding to a time period from a time the job is stored in the store to a time when resource allocation is made and execution is started. The waiting time information may include, for example, any one or any combination of information on when the job is stored in the store and information on a time elapsed from a time the job is stored to the start of execution after resource allocation is made.

As mentioned above, a job may be stored in the job queue of the system. Operation 310 may include recording job information by monitoring a job queue of a system in which jobs are stored. For example, monitoring the job queue may include generating the job information of a job based on enqueuing of the job queue and updating the job information of a job based on dequeuing of the job queue. The job managing server may detect the enqueuing of the job queue, that is, the job managing server may detect that a new job is or has been registered in the job queue, and then generate job information of that newly registered job. For example, the generated job information may include a job identifier of the job. The job managing server may detect the dequeuing of the job queue, that is, detect that a job is deleted from the job queue, and update job information of the corresponding job. Dequeuing of a job in the job queue may refer to the process where the computing resources of the system are allocated to the job and that job is likewise removed from the job queue. A state of a job deleted from the job queue may be changed from an execution pending state to an execution state, and accordingly, the job information may be updated. For example, in the job information, the corresponding information on a scheduling status of a job may be changed to information indicating an execution state of the job.

In an example, the management method of a job may include generating experiment information of a job based on dequeuing of the job queue. A state of a job deleted from the job queue may be changed from an execution pending state to an execution state, and accordingly, experiment information corresponding to the job may be generated. The experiment information of a job is described in detail below.

The management method of a job processed in the computer cluster system may include recording 320 experiment information of a job in connection with job information based on execution of the job in the cluster system.

In an example, the job managing server may record experiment information of one or more jobs executed in the system. The experiment information may be stored in a memory of the job managing server or in a storage space accessible from the job managing server.

The experiment information of a job may include information generated and/or derived from executing a job such as, for example, information for executing the job, information on a progress of job execution, and information on a result of executing the job.

For example, the experiment information of a job may include an experiment identifier of the job. The experiment identifier is information uniquely assigned to each job, and may include, for example, a character string generated by a combination of numbers and letters. The experiment identifier may be the same information as the job identifier or may be different information. When a job has a different experiment identifier and job identifier, mapping information between the experiment identifier and the job identifier for that job may be generated to link the experiment information and job information of that job together.

For example, the experiment information of a job may include parameter information on the execution of a job. The parameter information on the execution of a job may be variable information associated with the execution of a job, and may include, for example, values that are set for a batch size, data set, and learning rate (lr). The setting of the values for these, and other, parameters related to the execution of a job may be changed by a user input.

For example, the experiment information of a job may include measurement information on the execution of a job. The measurement information on the execution of a job may be information related to the progress of a job execution that may be measured as the job is executed, and may include, for example, any one or any combination of a learning rate, a loss, and the number of epochs measured according to the execution of a machine learning job.

For example, the experiment information of a job may include information on a computing resource that executes a job. The information on the computing resource that executes a job may be information indicating the computing resource allocated to the job and information indicating the computer cluster or computing device to which the computing resource allocated to the job belongs, and may include, for example, an amount (e.g., the number of CPUs, amount of memory) of the computing resource allocated to the job and an identifier of the computer cluster to which the computing resource allocated to the job belongs.

For example, the job's experiment information may include information on an execution time of that job. The information on the execution time of a job may be time information corresponding to a time period starting from a time when the computing resource is allocated to the job and the execution of the job starts until the execution of the job is completed, and may include, for example, any one or any combination of information on when the job is executed and information on a time taken for the execution of the job to be completed.

The management method of a job processed in the computer cluster system may include updating experiment information of a job based on execution of the job. The job's experiment information may be updated as the job is executed. For example, the experiment information could include measurement information based on outcomes derived from the execution of the job and the experiment information may be updated with the experiment information during the execution of the job. For example, the information on the execution time of a job may be updated as the job is executed.

in an example, the recording of the experiment information of a job in connection with the job information for that job may be referred to as mapping and recording the job information and the experiment information for that job. Accordingly, the job managing server may record the experiment information of a job in connection with the job information based on the job identifier.

In an example, the job information may include a job identifier of a job, and the recording 320 of the experiment information of a job in connection with the job information may include mapping the experiment information to the job identifier and recording the experiment information. The job information of a predetermined job may include a job identifier of the corresponding job. The job information including the job identifier mapped to the experiment information may be identified as the job information of a job corresponding to the experiment information. For example, when the experiment information of a first job is mapped to a job identifier “a111”, the job information including the job identifier “a111” may be identified as the job information of the first job.

In an example, the job information may include a job identifier of a job, and the experiment information may include an experiment identifier of a job. The recording 320 of the experiment information of a job in connection with the job information may include mapping the job identifier and the experiment identifier. The job managing server may generate and store mapping information of a job identifier and an experiment identifier of that job. The job information and experiment information of a same job may be identified using the mapping information. For example, the job managing server may generate a job identifier “b222” and an experiment identifier “2bbb” in response to a second job, and map the job identifier “b222” and the experiment identifier “2bbb” to information on the second job and store the information on the second job. The job managing server may identify the job information including the job identifier “b222” and the experiment information including the experiment identifier “2bbb” as job information and experiment information corresponding to the job identified as “2bbb”.

The management method of a job processed in the computer cluster system may include controlling 330 the execution of a job by transmitting a change in the experiment information based on the job information to the cluster system.

The controlling 330 of the execution of a job may include receiving inputs. In a non-limiting example, the inputs may include an input for controlling the job. For example, the input may be instructions to change the experiment information based on the job information. The controlling 330 may include transmitting the input to the cluster system so that a computing resource of the cluster system that is executing the job is controlled. In an example, the job managing server may receive the input to change the experiment information from a user or a user terminal. For example, the user terminal may transmit inputs, such as an input for changing the experiment information, to the job managing server through an interface for controlling the execution of the job based on the job information and experiment information of the job. The interface is described in detail below. The user may identify a predetermined job through the job information, and transmit an input for changing the experiment information of the predetermined job to the job managing server through the terminal. The job managing server may transmit the input for changing the experiment information to the cluster system. The computing resource executing the job may be controlled so that the job is executed based on the input for changing the experiment information.

In an example, the input for changing the experiment information may include any one or any combination of inputs that include instructions and/or commands that include interrupting an execution of a job, resuming the execution of a job, changing at least one parameter related to the execution of a job, and updating one or more parameters related to the execution of a job. In response to receiving an input for interrupting the execution of a job, a computing resource executing the corresponding job may be controlled to stop or pause an execution of the job. In response to receiving an input for resuming the execution of a job, a computing resource allocated to the corresponding job may be controlled to resume the execution of that job. In response to receiving an input for changing a parameter for a job, a computing resource executing the corresponding job update the job according to the changed parameter. In response to receiving an input for updating a parameter for a job, a computing resource executing the job may be updated with the controlled to execute the job according to the updated parameter. In this manner, a user may attempt to optimize a job parameter.

The management method of a job processed in the computer cluster system may include providing any one or any combination of the job information and the experiment information through an interface. An interface for providing any one or any combination of the job information and the experiment information is described in detail below.

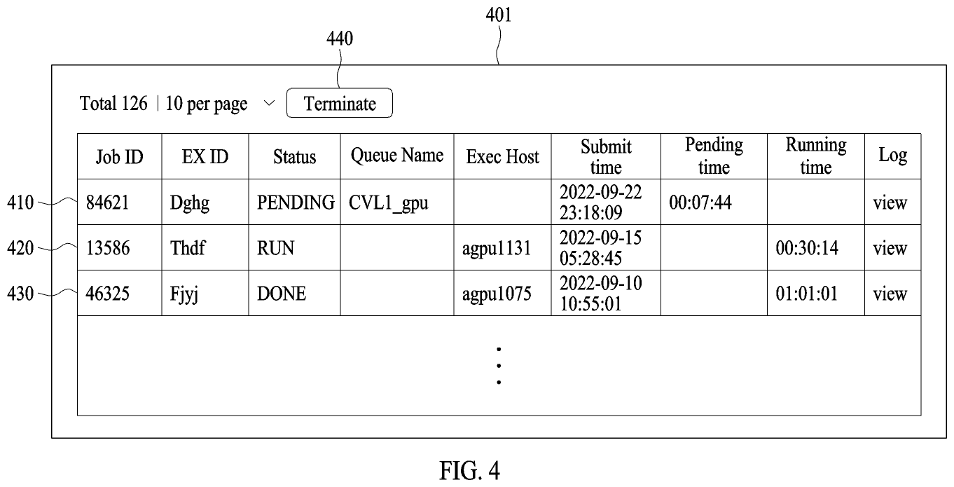

FIG. 4 illustrates an example interface screen for managing jobs output to a user terminal according to one or more embodiments.

Referring to FIG. 4, screen 401 may include a list of jobs being processed in a computer cluster system. In an example, the screen 401 may be provided through an interface. The list of jobs may include one or more items 410, 420, and 430 corresponding to the jobs processed in the computer cluster system. The items 410, 420, and 430 included in the list of jobs may include at least a portion of the job information and experiment information of a corresponding job.

For example, the items 410, 420, and 430 included in the list of jobs may include a job identifier (Job ID) and an experiment identifier (Ex ID). The job identifier (Job ID) and the experiment identifier (Ex ID) are unique values assigned to each job, and may be used to link job information and experiment information.

For example, the items 410, 420, and 430 included in the list of jobs may include time information (Submit time), indicating a time at which a job is submitted to the computer cluster system. The time information may be a time when the job is requested to be executed by the computer cluster system, and may include, for example, a time when the job is registered in the job queue of the system.

In an example, the items 410, 420, and 430 may include information on a scheduling status of a job (Status). The scheduling status information (Status) may include indication of a job's status, such as whether the job is in one of a pending state, a running state, and a done state.

The pending state may be a state in which a job has not yet been executed and computing resources are not allocated. The first item, Item 410, illustrates a job in the pending state, and therefore its status may not include information on a computing resource (Exec Host) that is executing the job. A job item that is in the pending state may include information on a job queue in which a job is stored (Queue name). The job queue information may include an identifier (e.g., CVL1_gpu) of the job queue. As illustrated in FIG. 4, item 410 corresponds to a job in the pending state and may include time information showing an amount of time for which the job has been stored in the job queue (pending time). The pending time information may correspond to an amount of time the job has been in the job queue. The pending time information may change as the waiting state of the job changes while being in the job queue. A value of the pending time information may increase with the passage of time until the job state is changed to a running state.

The running state may be a state in which a job is being executed by the computer cluster and has computing resources allocated to its execution. The second item, item 420, illustrates a job that is in the running state and may include information on a computing resource (Exec Host) executing the job. Information on the computing resource (Exec Host) executing the job may include an identifier (e.g., agpu1131) of the computing resource. Item 420 may include running time information indicating a running time of the job. The running time information of a job may correspond to a time the job has been running on the computer cluster system. The running time information of a job may change as the running state of the job continues. The running information value may change with the passage of time until that job's state screen 401 illustrated in is changed from the running state to another state (e.g., a done state or suspended state).

In a non-limiting example, the done state may be a state in which the execution of a job has ended, and may include any one or any combination of a terminated state in which the execution of a job has been completed and a terminated state in which the execution of a job has been terminated by a termination input of a user. A user may input a request to terminate a predetermined job through the interface. For example, the user may select an item corresponding to a job in the running state, and the select that the job be terminated by an input of selecting an interfacing object 440. Computing resources of a job in the done state may be deallocated.

In an example, because a job in the done state has a history of computing resources being allocated, the corresponding job may include information on the allocated computing resources. The third item, item 430, may be a job in the done state and may include an identifier (e.g., agpu1131) of a computing resource allocated before termination. Item 430 may include information on a running time of the job. Because a job is in the done state, it is a job in which execution has been terminated, and therefore its running time information may not change.

In an example, the information on the scheduling status of a job (Status) may include a suspended state. The suspended state may be a state in which the execution of a job has been temporarily suspended and the allocation of computing resources for the job may not be released. Execution of a suspended job may be resumed by an input of the user or through a predetermined execution condition.

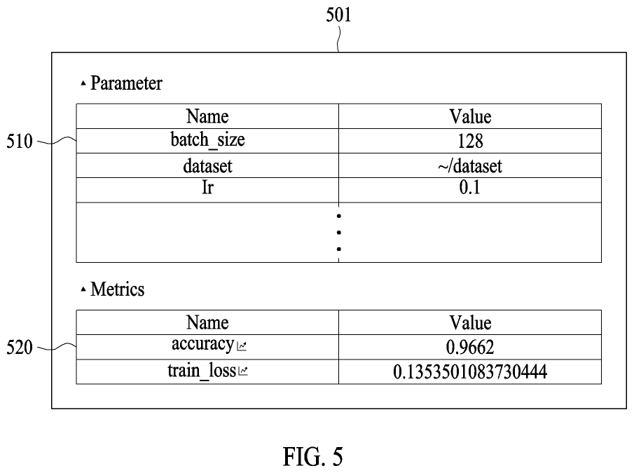

In an example, the user may request the job managing server to provide job information or experiment information of a job through an interface. For example, an interface screen 501 for providing information on a corresponding job is illustrated below in FIG. 5 which may be output in response to an input that selected one or more of the items 410, 420, and 430 corresponding to a predetermined job.

FIG. 5 illustrates an example interface screen for providing information on a job according to one or more embodiments.

Referring to FIG. 5, screen 501 may include information on a job processed in a computer cluster system which may be provided to a user terminal through an interface. The information on a job may include at least a portion of job information and experiment information.

For example, the information on a job may include information 510 on the parameters related to the execution of the job. In an example of a job for a machine learning experiment, information on the parameters related to the execution of a job may include parameter values related to a batch size, a data set, and a learning rate related to machine learning.

For example, the information on a job may include measurement information 520 related to the execution of the job. In an example of a job for a machine learning experiment, the measurement information related to the execution of the job may include measured values for the accuracy and loss of the machine learning experiment. The measurement information related to the execution of the job may be updated according to the execution of the job. For example, as the job is executed, a value of accuracy and a value of loss may change based on the execution of the job.

In an example, the user terminal may request to change parameter values through the interface. For example, the user terminal may input a command to change a batch size from 128 to 256 through the interface. The job managing server may transmit a command to change a parameter to the computer cluster system, and control the computer cluster system to execute a job for a machine learning experiment with the changed batch size.

In an example, the job managing server may transmit a command to update a parameter to the computer cluster system, and control the computer cluster system to execute a job for a machine learning experiment with the updated parameter.

In addition to the information illustrated in FIG. 5, various types of information related to a job may be provided through the interface. For example, logs generated by the execution of a job and files related to the logs may be provided. A request to download the logs and the related files generated by the execution of the job may be made through the interface, and the corresponding files may be downloaded to the user terminal. For example, the downloaded information may include command information related to a job, such as a job having no computing resources being allocated to it, may be registered in the job queue. In another example, information related to a storage path for a job, to which computing resources are not allocated, may be provided via the user terminal.

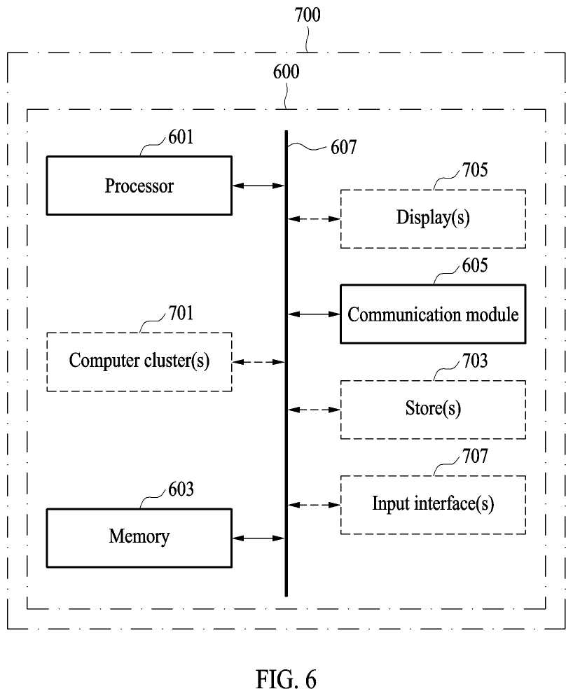

FIG. 6 illustrates an example configuration of an apparatus and computing system according to one or more embodiments.

Referring to FIG. 6, an apparatus 600 may include a processor 601, a memory 603, a communication module 605, and bus 607. In an example, the apparatus 600 may include any one or any combination of a computer cluster(s) 701, store(s) 703, display(s) 705, and/or input interface(s) 707. In an example, a computing system 700 may include any one or any combination of the apparatus 600, the computer cluster(s) 701, the store(s) 703, the display(s) 705, and/or the input interface(s) 707. In another example, the apparatus 600 may be a server.

In an example, the processor 601 may include plural processors, e.g., including the computer cluster(s) 701, and/or the memory 603 may include plural memories, e.g., including store 703. In an example, the bus 607 may be representative of a bus of the apparatus 600, providing communication among the example components of the apparatus 600, and is also representative of a bus of the computing system 700, providing communication among the example components of the computing system 700.

The apparatus 600 may be configured to perform any one, any combination, or all job management operations and/or methods of jobs processed in the computer cluster system described above with reference to FIGS. 1 to 5. For example, the apparatus 600 may be or include a job managing server (e.g., the job managing server 130 of FIG. 1 or the job managing server 130 of FIG. 2).

The processor 601 may further execute programs, and/or may control the apparatus 600, and may include any one or a combination of two or more of, for example, a central processing unit (CPU), a graphic processing unit (GPU), a neural processing unit (NPU) and tensor processing units (TPUs), but is not limited to the above-described examples.

The memory 603 may include computer-readable instructions. The processor 601 may be configured to execute computer-readable instructions, such as those stored in the memory 603, and through execution of the computer-readable instructions, the processor 601 is configured to perform one or more, or any combination, of the operations and/or methods described herein with respect to the job managing server described above with respect to FIGS. 1-5. In an example, the processor 601 and all operations and/or methods described with respect to FIGS. 1-5 or operations and/or methods described above with respect to operations and/or methods not performed by any of the above example job managing servers. The memory 603 may be a volatile or nonvolatile memory.

In a non-limiting example, the computer cluster(s) 701 may correspond to the computing system 100 of FIG. 1 and/or the HPC system 200 of FIG. 2. The computer clusters may be configured to perform the operations described above with respect to FIGS. 1-5. For example, the computer cluster(s) may also represent computer cluster 120 of FIG. 1 which may parallelly process operations for the execution of a job using the computing resources of a plurality of computing devices.

The processor 601 may perform at least one operation of the job managing server described above with reference to FIGS. 1 to 5. For example, the processor 601 may perform any one or any combination of recording job information of a job stored as a processing target of the system, recording experiment information of a job in connection with the job information based on the execution of a job of the cluster system, and controlling the execution of a job by transmitting a change in the experiment information to the cluster system based on the job information.

The memory 603 may store data related to the management method of a job processed in the computer cluster system described above with reference to FIGS. 1 to 5. For example, the memory 603 may store data generated in a process of performing the management method of a job processed in the computer cluster system or data necessary for performing the management method of a job processed in the computer cluster system. For example, the memory 603 may store the job information and experiment information of a job. The processor 601 and/or the memory 603 are also respectively representative of one or more processors and/or memories of the computing system 700. In an example, while the communication module 605 is illustrated among the apparatus 600, the communication module 605 may also be representative of an element of computing system 600.

The communication module 605 may provide a function for the apparatus 600 to communicate with other electronic devices or other servers through a network. In other words, the apparatus 600 may be connected to an external device (e.g., a user terminal, server, or network) through the communication module 605 to exchange data therewith.

In an example, the memory 603 may not be a component of the apparatus 600, but may be an external storage device (or database) accessible from the apparatus 600. In this example, the apparatus 600 may receive data (e.g., job information and experiment information) stored in the external storage device through the communication module 605 and transmit data to be stored in the memory 603.

The display(s) 705 may be implemented using a liquid crystal display (LCD), a light-emitting diode (LED) display, a plasma display panel (PDP), a screen, a terminal, or any other type of display configured to display the images and information to be displayed by the image display apparatus. A screen may be a physical structure that includes one or more hardware components that provide the ability to render a user interface and receive user input. The screen may include any combination of a display region, a gesture capture region, a touch-sensitive display, and a configurable area. The screen may be part of an apparatus 600 or computing system 700, or may be an external peripheral device that is attachable to and detachable from the apparatus. The display may be a single-screen display or a multi-screen display and may display, for example, the screen 401 and/or interface screen 501 as illustrated in FIGS. 4 and 5. A single physical screen may include multiple displays that are managed as separate logical displays permitting different content to be displayed on separate displays even though they are part of the same physical screen.

The input interface(s) 707 may include a touch screen provided in display(s) 705 or other input/output devices a user may operate to provide one or more types, of inputs, commands, or interaction to or with the apparatus 600 and/or the computing system 700, such as keyboards, a mouse, rollerball, and/or a microphone.

The apparatus 600 may further include other components not shown in the drawings. For example, the apparatus 600 may further include other components such as a transceiver, various sensors, and additional databases.

The processors, memories, networks, job managing server 130, apparatus 600, processor 601, memory 603, communications module 605, computing system 100, store 110, computer cluster 120, computing system 700, computer cluster(s) 701, store(s) 703, display(s) 705, and input interface(s) 707 described herein and disclosed herein described with respect to FIGS. 1-6 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method of a system including a processor, the method comprising:
recording experiment information of a job in connection with job information generated based on an execution of the job in a computer cluster system; and
controlling further execution, by the computer cluster system, of the job by transmitting a change in the experiment information to the computer cluster system based on the job information.

2. The method of claim 1, wherein the job information comprises a job identifier of the job, and
wherein the recording of the experiment information comprises mapping the experiment information to the job identifier of the job and recording the mapped experiment information.

3. The method of claim 1, wherein the job information comprises a job identifier of the job,
wherein the experiment information comprises an experiment identifier of the job, and
wherein the recording of the experiment information comprises mapping the job identifier and the experiment identifier.

4. The method of claim 1, further comprising:
updating the experiment information of the job, based on the execution of the job.

5. The method of claim 1, wherein the controlling of the further execution of the job comprises:
receiving an input and, based on the input, setting the change of the experiment information based on the job information; and
transmitting the input to change the experiment information to the computer cluster system so that a computing resource for executing the job of the computer cluster system is controlled.

6. The method of claim 5, wherein the system further includes the computer cluster system,
wherein the input to change the experiment information comprises one or more of:
an input for interrupting the execution of the job,
resuming the execution of the job, by the computer cluster system,
changing at least one parameter related to the execution of the job, and
updating the at least one parameter.

7. The method of claim 1, wherein the method further comprises recording the job information prior to the recording of the experiment information by monitoring a job queue, and
wherein the job is stored in the job queue of the computer cluster system.

8. The method of claim 7, wherein the monitoring of the job queue comprises:
generating the job information of the job based on an enqueuing of the job queue; and
updating the job information of the job based on a dequeuing of the job queue.

9. The method of claim 8, further comprising:
generating the experiment information of the job based on the dequeuing of the job queue.

10. The method of claim 1, wherein the job information comprises one more of:
a job identifier of the job,
information on a scheduling status of the job,
information on an execution code of the job. and
time information on a processing of the job.

11. The method of claim 1, wherein the experiment information comprises any or more of:
an experiment identifier of the job,
parameter information on the execution of the job,
measurement information on the execution of the job,
information on a computing resource executing the job, and
information on an execution time of the job.

12. The method of claim 11, wherein the job comprises a job for a machine learning experiment, and
wherein the experiment information includes the parameter information corresponding to parameters of the machine learning experiment.

13. The method of claim 1, further comprising providing one or more of the job information and the experiment information through an interface.

14. A system, the system comprising:
a server, including:
a processor configured to execute a plurality of instructions; and
a memory storing the plurality of instructions, wherein execution of the plurality of instructions configures the processor to be configured to:
record experiment information of a job in connection with job information based on an execution of the job in a computer cluster system; and
control the execution of the job by transmitting a change in the experiment information to a computer cluster system based on the job information.

15. The server of claim 14, wherein the system further comprises a memory store that is configured to store the job information and the experiment information.

16. The server of claim 14, wherein the processor is configured to record the job information and the experiment information in an external storage device of the system, and
wherein the server further comprises a communication module configured to communicate with the external storage device.

17. The server of claim 15, wherein the job information comprises a job identifier of the job, and
wherein the processor is configured to, for the recording of the experiment information of the job in connection with the job information:
map the experiment information to the job identifier of the job; and
record the mapped experiment information.

18. The server of claim 15, wherein the job information comprises a job identifier of the job,
wherein the experiment information comprises an experiment identifier of the job, and
wherein the processor is configured to, for the recording of the experiment information of the job in connection with the job information, map the job identifier and the experiment identifier.

19. The server of claim 15, wherein the processor is configured to, for the controlling of the execution of the job:
receive an input to change the experiment information based on the job information, and
transmit the input to the computer cluster system to control a computing resource for executing the job of the computer cluster system.
